(19) United States
(12) Patent Application Publication
(10) Pub. No.: US 2010/0036297 A1
(43) Pub. Date: Feb. 11, 2010

(54) CHAIR HAVING EXERCISE FUNCTION OF SONIC VIBRATION TYPE

(75) Inventor: Seong Bae Kim, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignee: TS MEDITECH CO. LTD., WONJU-SI, GANGWON-DO (KR)

(21) Appl. No.: 12/527,958

(22) PCT Filed: Feb. 20, 2008
(86) PCT No.: PCT/KR08/00976

§ 371 Date: Aug. 20, 2009

(30) Foreign Application Priority Data
Feb. 22, 2007 (KR) 10-2007-0018050

(51) Int. Cl. A61H 1/00

(52) U.S. Cl. 601/49

(57) ABSTRACT

Provided is a chair having a sonic vibration type exercise function which enables a user to make an exercise and to undergo medical treatment using vibration at a state where the user sits on or lies down on the chair. The chair includes a seat, a vibration generator which is placed at the lower part of the seat and provides vertical vibration for the seat, a seat housing which supports the vibration generator at the lower part of the seat, and a support which supports the lower part of the seat housing on the ground, to thereby make the seat vertically vibrate by an electromagnetic force of the vibration generator and enable a user sitting on lying down on the seat to make an exercise and take a cure treatment.

### TECHNICAL FIELD

The present invention relates to a chair having a sonic vibration type exercise function, and more particularly, to a functional chair having a sonic vibration type exercise function which enables a user to make an exercise and to undergo medical treatment using vibration at a state where the user sits on or lies down on the chair.

### BACKGROUND ART

In general, office workers frequently work for long hours on chair, and furthermore are exercising less. Thus, in order to keep healthy body, it is desirable to make a simple exercise regularly through a break.

However, it is actually difficult to use spare time for exercise on the way to work for business. Accordingly, physical enfeeblements by lack of exercise became an inescapable problem.

A massage chair was introduced in Korean Utility-model Registration No. 20-420668 to solve the above-described problem.

As shown in FIG. 1, the massage chair includes a seat 10 and a chair back 11, in which solenoids 12 and 13 and diaphragms 14 that produce vibration for massage are installed into and onto the seat 10 and the chair back 11, respectively. Accordingly, a user who sits on the massage chair can receive massage.

However, the massage chair adopts the solenoids 12 and 13 which can generate relatively feeble impacts. Thus, the massage chair is used only for massage of local body but cannot impose vibration shock to the whole body, to thereby cause a weak exercise effect.

Meanwhile, a chair for bodily sensation of acoustic vibration is illustrated in FIG. 2 of Korean Utility-model Registration No. 20-419026. Here, a speaker 18 that produces acoustic sound is incorporated in the inside of a seat 16 of a chair which includes the seat 16 and a chair back 17. Accordingly, a user who sits on the acoustic vibration bodily sensation chair can listen to audio sound by the ears and bodily sense the audio sound by the body, in synch with the ears.

That is, the acoustic vibration bodily sensation chair employs a binding structure between a cushion portion and a vibration portion that strengthen a sense of unity by an insert foam molding method, and a frame structure which is formed of a hitting net shape of nonferrous metal. Accordingly, an effect of enhancing a productivity can be obtained because of reduction in manpower for manufacture. In particular, according to an excellent vibration transfer effect between the cushion portion and the vibration portion, a user who sits on the acoustic vibration bodily sensation chair can experience actual feeling by enhancing a sense of presence and a cubic effect.

However, since the acoustic vibration bodily sensation chair makes a user feel acoustic vibration through the skins of user's buttock and femoral region in the lower body, there is a problem that the user cannot attain an exercise effect which can be obtained by applying vibration to the whole body.

Meanwhile, this inventor proposed a magnetic circuit using a dual magnet and a speaker and a vibration generator using the magnetic circuit in Korean Patent No. 651766, and proposed a vibration type exercising apparatus using the vibration generator in Korean Patent No. 620147.

The vibration type exercising apparatus applies vibration to the physical body at a state where both feet are put on the vibration generator, and thus is an effective exercising apparatus which is used for making an exercise of the whole body, especially treating abdominal obesity.

However, the vibration type exercising apparatus applies vibration generated from the vibration generator very strongly to both feet. That is, even in the case that a user of 200 Kg stands on a diaphragm of the vibration generator, the user can make an exercise of vertical movement not less than 10 mm.

Therefore, in the case of using the vibration type exercising apparatus for aerobic activity, a healthy person has the advantage of enhancing an exercise effect in a stand-up posture. However, the vibration type exercising apparatus is not appropriate in its structure for the uncomfortable disabled person, the old or weak or the child, or the patient who undergoes rehabilitation treatment or the patient who is in the hospital and suffers from living a bed life for a long time to use it.

### [Disclosure]

### [Technical Problem]

This inventor invented a functional chair considering that the vibration generator which can produce a strong vibratory force is applied to a chair, preferably, a chair which can be transformed into a bed, to thereby be appropriately used as a medical rehabilitation treatment apparatus or exercising apparatus which enables the uncomfortable disabled person, the old or weak or the child, or the patient who undergoes rehabilitation treatment or the patient who is in the hospital and suffers from living a bed life for a long time to make a light exercise or perform physiotherapy.

To solve the above problems, it is an object of the present invention to provide a functional chair having a sonic vibration type exercise function, which applies periodic vertical vibration to users body when a user sits on the chair for exercise and treatment, to thereby reveal an exercise and curative effect.

It is another object of the present invention to provide a functional chair having a sonic vibration type exercise function, including a tread board and a chair back which can be pivotably provided, so that the chair can be transformed into a bed as necessary, to thereby be used as a medical functional bed and enable a user to lie down on the medical functional bed to make an exercise and receive a medical treatment.

It is still another object of the present invention to provide a functional chair having a sonic vibration type exercise function, in which a low-frequency driving signal for a diet exercise and an audio signal for listening to music are selectively applied or simultaneously overlapped each other to then be applied to a diaphragm, to thereby enable the diaphragm to operate at low-frequency signals and a user to listen to music according to reproduction of audio signals and to accordingly enable the user to make an exercise while listening to music without using a special audio signal sound reproduction system such as a speaker.

### [Technical Solution]

To accomplish the above object of the present invention, according to an aspect of the present invention, there is provided a chair having a sonic vibration type exercise function, the chair comprising:

a seat;

a vibration generator which is placed at the lower part of the seat and provides vertical vibration for the seat;

a seat housing which supports the vibration generator at the lower part of the seat; and

a support which supports the lower part of the seat housing on the ground, wherein the vibration generator comprises:

a base which is placed on the seat housing;

a controller which generates a driving signal,

at least one vertical vibration unit having a diaphragm which is placed on the base so as to be vibrated up and down, and which is vibrated up and down when the driving signal is applied to a driving coil which is wound around the outer circumference of a bobbin which is connected with the diaphragm by a magnetic gap driving method and is disposed in the magnetic gap;

a number of guides whose both ends are connected with the base and the diaphragm, to thereby guide vertical movement of the diaphragm; and

a number of vibration absorption units which restrict the range of motion of the diaphragm when the diaphragm moves in the vertical direction, and which absorbs impact when the diaphragm descends.

According to a second characteristic of this invention, there is provided a chair having a sonic vibration type exercise function, the chair comprising:

a seat;

a vibration generator which includes a diaphragm which is placed at the lower part of the seat and provides vertical vibration for the seat, so as to be vibrated up and down, and which enables the diaphragm to be vibrated up and down when a driving signal is applied;

a controller that produces the driving signal to vibrate the diaphragm of the vibration generator;

a seat housing which supports the vibration generator at the lower part of the seat; and

a support which supports the lower part of the seat housing on the ground, wherein

the vibration generator comprises:

at least one vertical vibration unit including: having lower and upper magnets which are arranged at a predetermined distance from each other so as to face each other and produces a non-alternating magnetic field; a first yoke which includes a loop type circulation circuit portion which is extended to the upper surface of the upper magnet from the lower surface of the lower magnet, and an extension portion which is extended vertically upwards at a predetermined interval from the inner circumference of the lower side of the lower magnet in an integral form; a second yoke which is connected between the lower and upper magnets and which forms a magnetic gap between the inner circumferential surface of the first yoke and the outer circumferential surface of the extension portion of the first yoke; a driving coil which generates an alternating magnetic field when the driving signal is applied thereto, and which is arranged in the magnetic gap, to then be displaced up and down according to interaction with a non-alternating magnetic field generated from the lower and upper magnets; and a cylindrical bobbin around which the driving coil is wound;

a joint whose one end is combined with the upper portion of each bobbin;

a diaphragm which is combined with the other end of the joint;

a base on one surface of which the vertical vibration unit is installed;

a number of guides whose both ends are connected with the base and the diaphragm, to thereby guide vertical movement of the diaphragm; and

a number of vibration absorption units which restrict the range of motion of the diaphragm when the diaphragm moves in the vertical direction, and which absorbs impact when the diaphragm descends.

In the chair according to the first aspect of the present invention, the magnetic circuit that forms the magnetic gap in the vertical vibration unit comprises any one of an internal magnetic type permanent magnet, an external magnetic type permanent magnet, a combination of permanent magnets having a pair of an internal magnetic type permanent magnet and an external magnetic type permanent magnet, and an electromagnet.

The controller may comprises: a control unit which produces a control signal corresponding to an input set by user's manipulator; a signal generator which generates a sinusoidal driving signal having an oscillation signal set according to the control signal; and an amplifier for amplifying the sinusoidal driving signal.

In addition, the chair further comprises a tread board whose one end is pivotably connected with the front end of the seat, and a chair back whose lower end is pivotably connected with the rear end of the seat.

Moreover, the controller further comprises a manipulator which sets a signal of controlling the number of vibrations and the amplitude of vibrations of the vertical vibration unit.

The guide may comprise a guide bearing which is placed in the base and a guide rod which is placed in the diaphragm and combined with the guide bearing.

The lower and upper magnets are arranged so that the respective N-poles face each other, and are formed of a number of sectional type disks made of neodymium.

In addition, the chair according to this invention further comprises a pair of arm rests which are installed in the left and right sides of the seat, respectively, and a display which is installed on the upper portion of the one arm rest and which is connected with the controller, to thereby display an operational state of the vibration generator.

Moreover, the chair according to this invention further comprises a load sensor that is placed in the diaphragm to sense a load. Here, the controller detects user's weight who stands on the diaphragm through the load sensor, to thereby drive the vertical vibration unit at the number of vibrations and the amplitude of vibrations which are appropriate for the sensed weight.

It is possible to install the number of the guides and the number of the vibration absorption units at an identical point in place.

In the chair according to this invention, an oscillation frequency of the signal generator is set in the range of 0.1 Hz to 20 kHz, and a desired frequency band may be set and used according to user's need.

In addition, the driving signal is one of a low-frequency driving signal for a diet exercise, an audio signal or listening to music, and a signal which is obtained by overlapping a low-frequency driving signal and an audio signal.

### [Advantageous Effects]

As described above, the present invention provides a chair having a sonic vibration type exercise function, which applies periodic vertical vibration to user's body when a user sits on the chair for exercise and treatment, to thereby reveal an exercise and curative effect.

In addition, the present invention provides a chair having a sonic vibration type exercise function, including a tread board and a chair back which can be pivotably provided, so that the chair can be transformed into a bed as necessary, to thereby be used as a medical functional bed and enable a user to lie down on the medical functional bed to make an exercise and receive a medical treatment.

Moreover, the present invention provides a chair having a sonic vibration type exercise function, which uses magnets and coils as a vertical vibration generator. Accordingly, a mechanical shock occurs less frequently in operation, to thereby reduce generation of noise due to use of the mechanical components in the chair, to thus prevent excessive shock from being transferred to user's body.

Furthermore, the present invention provides a chair having a sonic vibration type exercise function, in which a low-frequency driving signal for a diet exercise and an audio signal for listening to music are selectively applied or simultaneously overlapped each other to then be applied to a diaphragm, to thereby enable the diaphragm to operate at low-frequency signals and a user to listen to music according to reproduction of audio signals and to accordingly enable the user to make an exercise while listening to music without using a special audio signal sound reproduction system such as a speaker.

### DESCRIPTION OF DRAWINGS

The above and other objects and advantages of the present invention will become more apparent by describing the preferred embodiments thereof in detail with reference to the accompanying drawings in which:

FIG. 1 is a side view of a conventional massage chair;

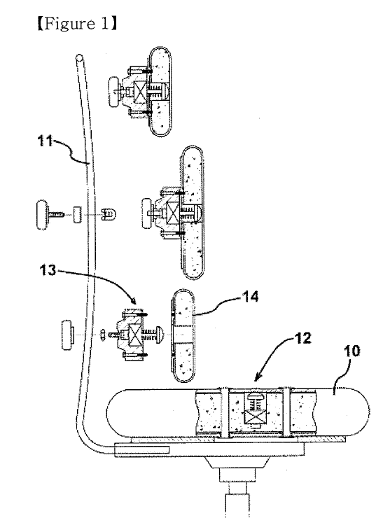

FIG. 2 is a perspective view of a conventional chair for bodily sensation of acoustic vibration;

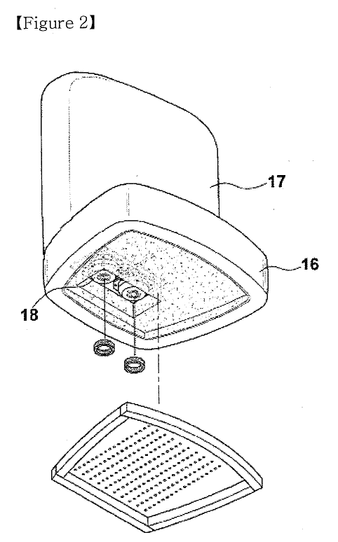

FIG. 3 is a front view of a chair having a sonic vibration type exercise function according to this invention;

FIG. 4 is a side view of a chair having a sonic vibration type exercise function according to this invention;

FIG. 5 is a front-side cross-section view of a permanent magnet style vibration generator for use in the chair having a sonic vibration type exercise function according to a first embodiment illustrated in FIG. 4;

FIG. 6 is a dissolved cross-sectional view of the permanent magnet style vibration generator illustrated in FIG. 5;

FIG. 7 is a schematic top-view cross-sectional view of the permanent magnet style vibration generator according to this invention;

FIG. 8 is a dissolved cross-sectional view of a vertical vibration unit according to this invention;

FIG. 9 is a schematic block diagram to explain a control system which is used in a sonic vibration type exercise function chair according to this invention;

FIG. 10 is a cross-sectional view of an electromagnet style vibration generator for use in a sonic vibration type exercise function chair according to a second embodiment of this invention;

FIG. 11 is a cross-sectional view showing a coupling structure of a spring with a guide;

FIG. 12 is a cross-sectional view of a permanent magnet style vertical vibration unit for use in a sonic vibration type exercise function chair according to a third embodiment of this invention; and

FIG. 13 is a cross-sectional view of a permanent magnet style vertical vibration unit for use in a sonic vibration type exercise function chair according to a fourth embodiment of this invention.

### BEST MODE

Hereinbelow, a sonic vibration type exercise function chair according to a preferred embodiment of the present invention will be described with reference to the accompanying drawings. Like reference numerals denote like elements through the following embodiments.

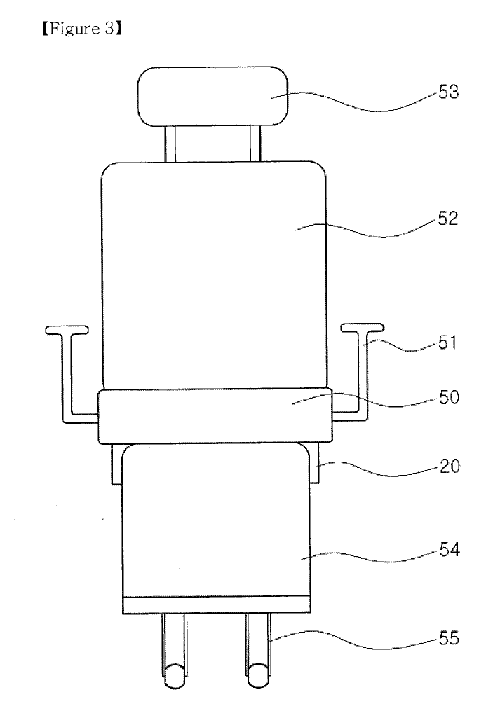

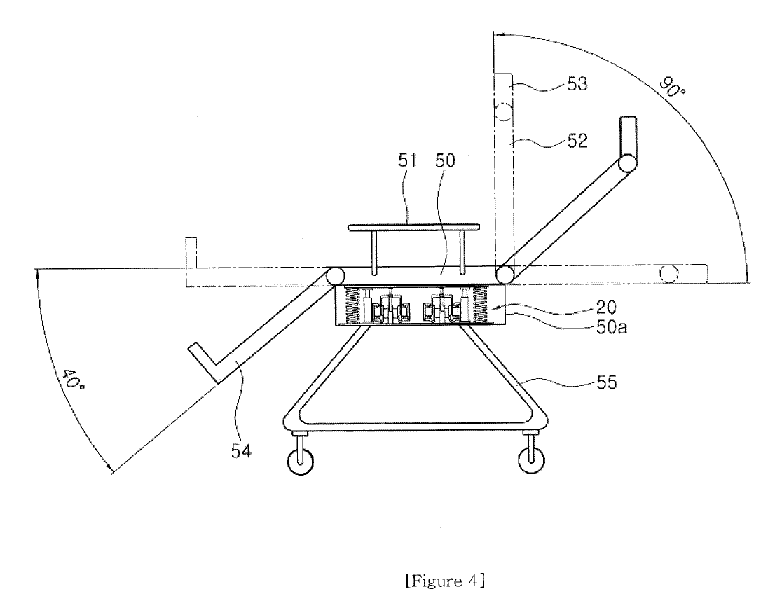

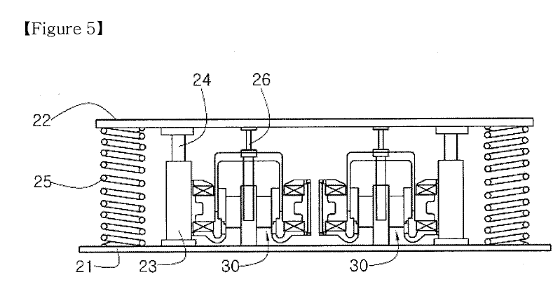

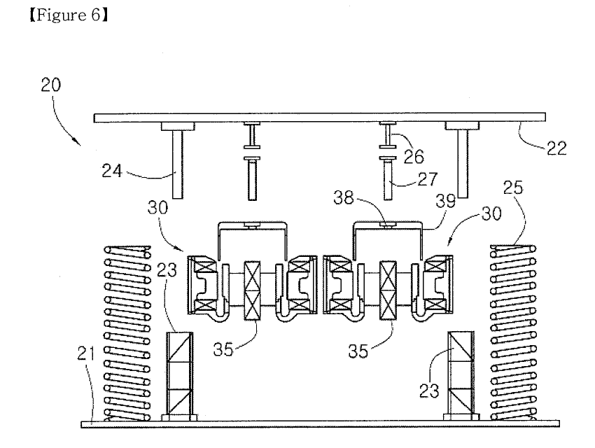

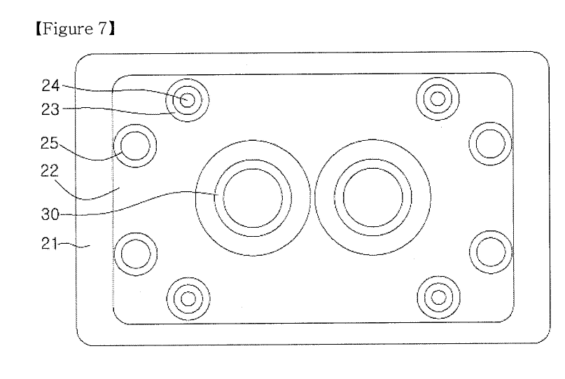

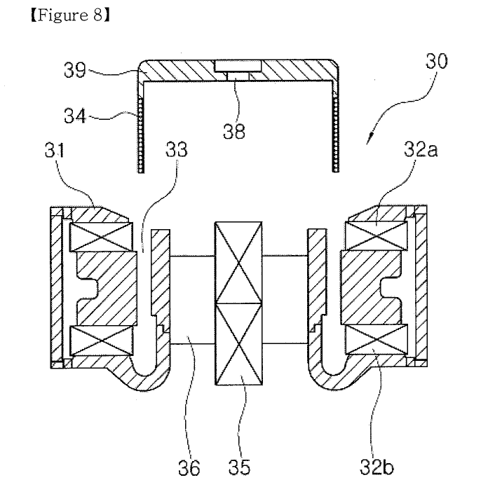

FIG. 3 is a front view of a chair having a sonic vibration type exercise function according to this invention. FIG. 4 is a side view of a chair having a sonic vibration type exercise function according to this invention. FIG. 5 is a front-side cross-section view of a permanent magnet style vibration generator for use in the chair having a sonic vibration type exercise function according to a first embodiment illustrated in FIG. 4. FIG. 6 is a dissolved cross-sectional view of the permanent magnet style vibration generator illustrated in FIG. 5. FIG. 7 is a schematic top-view cross-sectional view of the permanent magnet style vibration generator according to this invention. FIG. 8 is a dissolved cross-sectional view of a vertical vibration unit according to this invention.

As shown in FIGS. 3 and 4, a chair having a sonic vibration type exercise function according to this invention includes: a seat 50; a pair of arm rests 51 which are connected with both side ends of the seat 50; a chair back 52 which is connected with the rear end of the seat 50; a head rest 53; a tread board 54 which is connected with the front end of the seat 50; a support 55 which supports the lower part of the seat 50 on the ground; and a vibration generator 20 which is mounted at the lower portion of the seat 50 and generates vibration. In this case, the vibration generator 20 is surrounded by a seat housing 50s, and is supported at the lower portion of the seat 50. Thus, the support 55 supports the lower part of the seat housing 50a.

Here, the arm rests 51, the chair back 52, the head rest 53, the tread board 54, and so on are have been described as the components of the chair. The present invention may include the seat 50 as a basic component, and additionally may include only the vibration generator 20. As shown in FIG. 4, the chair back 52 and the tread board 54 may be connected in a pivotable structure by a mutual connection unit so as to be extended and contracted back and forth.

Therefore, as shown as dotted lines in FIG. 4, the chair back 52 and the tread board 54 may be disposed on one plane together with the seat 50. In this case, it is possible to use the chair as a rest or medical bed.

As shown in FIGS. 5 to 8, the vibration generator 20 according to the first embodiment of the present invention includes a pair of vertical vibration units 30 using a permanent magnet, a base 21, a diaphragm 22, and so on.

As shown in FIG. 8, the vertical vibration unit 30 has a structure that first and second magnetic circuits are formed using an external magnetic type style magnet 32b and an internal magnetic type style magnet 32a, a uniform distribution of the line of the magnetic force is realized on the surface opposed to a yoke 31 which forms a magnetic gap 33 of the first magnetic circuit including the external magnetic type style magnet 32b, a flux leakage of the magnetic gap 33 is prevented by the loop type second magnetic circuit including the internal magnetic type style magnet 32a, and a bobbin 39 around which a drive coil 34 for driving the diaphragm 22 up and down is wounded is inserted into the magnetic gap 33 formed in the first magnetic circuit.

The external magnetic type style magnet 32b and the internal magnetic type style magnet 32a that provide the magnetic force of the first and second magnetic circuits use magnets which are molded into disc shaped division pieces using a neodymium magnetic material having a flux density not less than 11.5 times than that of the conventional ferrite magnetic material, and then is strongly magnetized by a direct magnetization method.

Therefore, this invention uses neodymium magnets having a strong magnetic force and which have been directly magnetized beforehand. Thus, this invention can use inexpensive direct magnetization equipment instead of expensive indirect magnetization equipment, to thus reduce an equipment investment expense. In addition, magnetization is rapidly achieved by using a direct magnetization method.

In addition, in assembly of the magnets, a number of division pieces are used to then be fixed to the yoke 31 by an adhesive. As a result, the present invention does not cause a problem that the other components are absorbed by a strong absorption force at the time of assembling a single annular magnet, and a problem that components are repelled by a strong repelling force at the time of assembling magnets of an identical polarity Moreover, it is of course possible to use magnets which are formed by assembling ferrite or other magnetic substance of an annular shape and are then be magnetized, as the magnets 32a and 32b.

The first magnetic circuit includes the external magnetic type style magnet 32b, an extension portion which is extended upwards in the form of a pole piece at a distance from the inner circumference of the outer portion of the yoke 31 which is disposed at the lower portion of the external magnetic type style magnet 32b, and the inner portion of the yoke 31 which is disposed at the upper portion of the external magnetic type style magnet 32b in which the magnetic gap 33 is formed between the inner portion of the yoke 31 and a surface opposed to the extension portion of the pole piece form. The second magnetic circuit includes the inner portion of the yoke 31, the internal magnetic type style magnet 32a at the upper portion of the inner portion of the yoke 31, to have the same polarity (for example, an S-pole) as that of the external magnetic type style magnet 32b, and a loop type circulation circuit which is extended from the upper end of the internal magnetic type style magnet 32a to the lower end of the external magnetic type style magnet 32b.

The loop type circulation circuit forms the outer portion of the yoke 31 integrally with the extension portion. In addition, the inner portion of the yoke 31 is branched in a linear shape, respectively, and is symmetrically extended from the opposing surface forming the magnetic gap 33 to the upper surface of the external magnetic type style magnet 32b and the lower surface of the internal magnetic type style magnet 32a, to thereby form a path of the line of the magnetic force.

As a result, the internal magnetic type style and external magnetic type style magnets 32a and 32b having an identical dimension and polarity are disposed in a symmetric structure at the upper and lower portions of the inner portion of the yoke 31 in the first and second magnetic circuits, respectively. Accordingly, the line of the magnetic force which is generated from the extension portion of the outer portion of the yoke 31 does not lean upon any one of the upper and lower portions of the inner portion of the yoke 31, but is fed back to the internal magnetic type style and external magnetic type style magnets 32a and 32b via the inner portion of the yoke 31. As a result, a uniform distribution of the line of the magnetic force is formed on the opposing surface of the yoke 31, to thus improve a linear response (rectilinearity of a coil) in a vibration system.

In addition, the inner portion of the yoke 31 which forms the S-pole is surrounded by the outer portion of the yoke 31 which forms the N-pole and the internal magnetic type style and external magnetic type style magnets 32a and 32b. Accordingly, a flux leakage phenomenon is suppressed to thus reinforce a driving force with respect to the vibration system and increase a magnetic efficiency.

A bobbin 39 around which a drive coil 34 is wound and which is inserted into the magnetic gap 33 of the first magnetic circuit is connected with a diaphragm 22 via a joint 26.

In addition, a bobbin guide 35 which is formed of a guide bearing is installed at the center of the inner portion of the yoke 31. One end of a bobbin guide rod 27 which is combined with the bobbin guide 35 is fixed to one end of the joint 26 through the central part 38 of the bobbin 39 together with the bobbin 39.

Meanwhile, a heat radiation pipe 36 of a material whose heat transfer conductivity is excellent, for example, an aluminium material is inserted into the inner portion of the yoke 31, in order to radiate heat generated from the driving coil 34, the internal magnetic type style and external magnetic type style magnets 32a and 32b and the yoke 31, quickly to the outside by an air cooling method. Thus, the bobbin guide 35 is installed at the center of the heat radiation pipe 36.

The heat radiation pipe 36 plays a role of supporting the bobbin guide 35, in addition to the heat radiation function, and also plays a role of minimizing a magnetic force which influences upon the bobbin guide 35 which is located at the inner side from the extension portion of the outer portion of the yoke 31 having the N-pole, and inducing the line of the magnetic force to be concentrated toward the magnetic gap 33.

In addition, the bobbin 39 is manufactured by injection molding of a plastic material, in which the central parts 38 of the bobbin 39 which is combined with the upper portion of the bobbin guide rod 27 is formed thickly and the cylindrical portion thereof around which the driving coil 34 is wound is formed thinly, considering an interval of the magnetic gap 33. Here, a portion of the bobbin 39 around which the driving coil 34 is wound is may be achieved in the form of a groove. In this case, the wound driving coil 34 is formed of a multilayer structure of four or more layers in order to increase an allowable input.

In addition, the bobbin 39 may be made of a metal material such as aluminium or brass. In the case that the bobbin 39 is manufactured in small size, it may be formed of a film.

As described above, the bobbin guide 35 is provided in this invention. Accordingly, although a big input is applied to the driving coil 34 and thus the diaphragm 22 vibrates greatly up and down, the bobbin 39 is guided so that the vertical vibration unit 30 performs the rectilinear movement in the vertical direction without left and right eccentricity.

In this invention, in order to make the magnetic force efficiently reach the drive coil 34 which is inserted into the magnetic gap 33 and vibrates up and down, it is desirable that the mutually opposing surfaces of the magnetic gap 33 are formed lengthily so that the driving coil 34 covers sufficiently a vibrating range.

The vertical vibration unit 30 is installed between the base 21 and the diaphragm 22. A number of guides 23 made of vertical bearings are installed in the base 21 in the neighborhood of the verticality vibration unit 30, to improve vertical motility of the diaphragm 22. A guide rod 24 that is combined with the guide 23 is fixed to the lower part of the diaphragm 22.

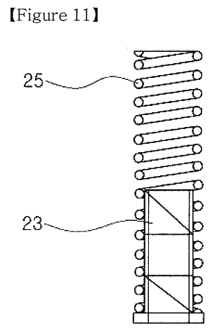

In addition, in order to mitigate impact that is imposed through the diaphragm 22, a number of springs 25 are symmetrically dispersedly disposed, so that both ends of each spring are fixed to the upper surface of the base 21 and the lower surface of the diaphragm 22, respectively. In this case, as shown in FIG. 11, a number of the springs 25 are positioned to surround a number of the guides 23. Accordingly, it is possible to reduce the whole size of the vibration generator.

The joint 26 is linked between the diaphragm 22 and the bobbin 39, to play a role of transferring vertical vibration generated from the bobbin 39, to the diaphragm 22. The following condition should be met.

That is, the joint 26 should have a structure such as a pillar in order to transfer vertical movement. In addition, the joint 26 should be able to accommodate a rotational and transferable displacement as much as a clearance of the bobbin guide 35 in the horizontal direction. This clearance is not more than 1 mm. Accordingly, if a pillar of the minimum area that do not cause a buckling phenomenon is put up to transfer vertical movement, the above-described condition can be satisfied.

By using the joint 26 of such a simple structure, expenses are minimized, possibilities of generating noise are taken away and durability is heightened. It is desirable use an elastic body such as a spring as quality of the material of the joint 26. Here, the buckling phenomenon means that a thin vertical member is compressed and then collapses.

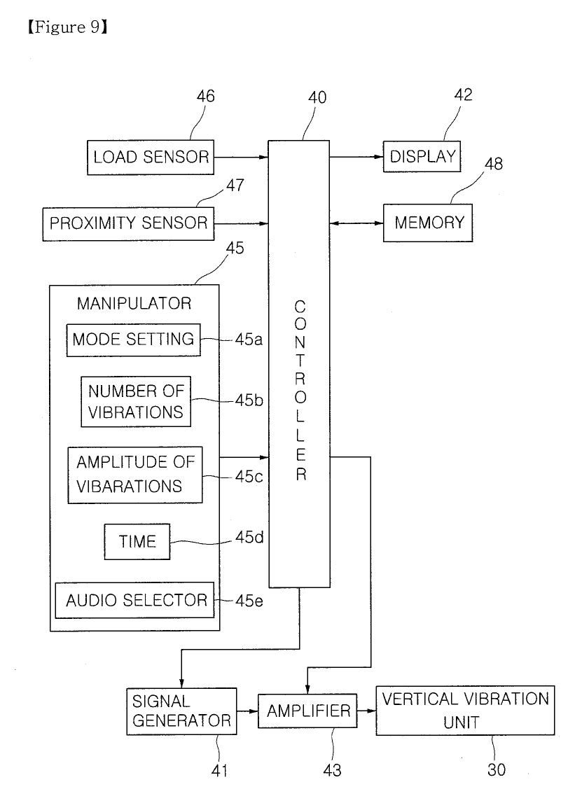

Meanwhile, FIG. 9 is a schematic block diagram to explain a control system which is used in a sonic vibration type exercise function chair according to this invention.

As shown in FIG. 9, a load sensor 46 which senses user's weight and a proximity sensor 47 that is a kind of an object sensor to confirm whether or not to access the other objects are installed on the diaphragm 22 which is installed on the vibration generator 20 of FIG. 6, and results measured by the load sensor 46 and the proximity sensor 47 are input to the controller 40. For example, the controller 40 may be implemented using a microprocessor or a central processing unit (CPU), or a microcontroller having a system control memory according to need.

A manipulator 45 which includes: a mode setting knob 45a which sets operation of the vibration generator 20, that is, operation of the system into an automatic mode or a manual mode; a vibration number setting knob 45b which sets the number of vibrations of the diaphragm 22; a vibration width setting knob 45c which sets the amplitude of vibrations of the diaphragm 22; and a time setting knob 45d which sets an operating time, is installed, for example, on the upper end of an arm rest 51, together with a display 42, and is connected with the controller 40. In addition, a memory 48 which stores data regarding the vibrating conditions of the vibration generator 20, for example, an optimum number of vibrations and an amplitude of vibrations by user's weight and a system control program is connected with the controller 40.

Therefore, in the case that the controller 40 is set at an automatic mode by user's manipulation through a mode setting knob 45a of the manipulator 45, it detects user's load through the load sensor 46 and calculates the optimum number of vibrations and the amplitude of vibrations by the user's weight, using data stored in the memory 48, to thus control a driving signal that is applied to the driving coil 34 of the vertical vibration unit 30. Meanwhile, in the case that the controller 40 is set at a manual mode by user's manipulation through the mode setting knob 45a of the manipulator 45, it generates a control signal according to the number of vibrations and the amplitude of vibrations which have been set by the user, to thus set the number of vibrations of the signal generator 41, and controls an output magnitude of an amplifier 43 to thus set the amplitude of vibrations.

In addition, the controller 40 is possible to confirm whether or not the user uses the chair according to the present invention through the proximity sensor 47 and the load sensor 46. Accordingly, if the user stops using the chair, that is, the user stands up from the chair during operation of the vibration generator 20, the vertical vibration unit 30 immediately stops the operation.

Here, a pair of the vertical vibration units 30 are driven by the amplifier 43 under the control of the controller 40. The amplifier 43 receives a sinusoidal driving signal generated from a signal generator 41, and amplifies the received sinusoidal signal, to thus make the pair of the vertical vibration units 30 which are the respective components of the vibration generator 20 vibrate by the sinusoidal driving signal.

For example, the amplifier 43 may include a pre-amplifier which primarily amplifying the sinusoidal driving signal generated from the signal generator 41 and a power amplifier that power-amplifies the output from the pre-amplifier.

If the user sets the number of vibrations and the amplitude of vibrations, that is, the vibration strength in the case that the controller 40 is set at the manual mode, the controller 40 applies the control signal to the signal generator 41. Accordingly, an oscillating frequency of the sinusoidal driving signal generated from the signal generator 41 is controlled, and an output of the power amplifier is controlled to thus control the vibration strength of the vibration generator 20.

Meanwhile, the driving signal of the controller 40, which is applied to the drive coils 34 of the vertical vibration units 30 is preferably an audio signal, that is, a sinusoidal signal.

In the embodiment that is illustrated in FIGS. 4 to 8, the vibration generator which is implemented using a magnetic circuit that uses the permanent magnets has been described, but it is apparent to one skilled in the art to use a vibration generator using an electromagnet as in another embodiment of the present invention which will be described below.

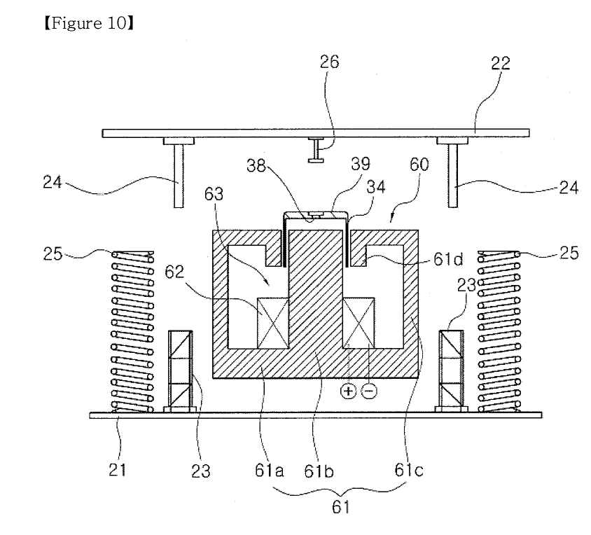

FIG. 10 is a cross-sectional view of an electromagnet style vibration generator for use in a sonic vibration type exercise function chair according to a second embodiment of this invention.

Excepting that the electromagnet style vibration generator for use in a sonic vibration type exercise function chair according to the second embodiment of this invention uses an electromagnet as a vertical vibration unit 60, the other components thereof are same as those of the permanent magnet style vibration generator for use in a sonic vibration type exercise function chair according to the first embodiment of this invention. Accordingly, like reference numerals denote like elements, and the detailed descriptions thereof will be omitted.

The electromagnet style vertical vibration unit 60 has a structure that a bobbin 39 around which driving coils 34 are wound is inserted into a magnetic gap formed in a magnetic circuit using an electromagnet 63, in order to drive a diaphragm 22 up and down.

The electromagnet 63 plays a role of inducing the driving coils 34 to move up and down according to the Fleming's left-hand law. Here, a yoke 61 is mounted at the center of a base 21 through an insulating material that is not illustrated. A coil 62 through which a direct-current (DC) voltage is applied is wound around the yoke 61. Accordingly, a strong and continuous DC magnetic flux is supplied to the magnetic circuit.

The yoke 61 that forms the magnetic circuit includes: a circular base 61a which is located at the center of the base 21; a rod-shaped center pole 61b which is protruded upwards from the center of the base 61a and around which the coil 62 for the electromagnet is wound; a cylindrical outer extension portion 61c which is extended as high as the center pole 61b upward from the end of the base 61a; and a magnetic gap formation portion 61d which is extended and bent at two stages inward from the outer extension portion 61c to thus form the magnetic gap with respect to the upper end of the center pole 61b.

Therefore, the yoke structure has a space structure that a sufficient amount of the coil for the electromagnet between the center pole 61bs and the outer extension portion 61c can be wound, to thus form a strong electromagnet. In this case, in order to make a magnetic force efficiently reaches the driving coil 34 which is inserted into the magnetic gap to then vibrate up and down, the magnetic gap formation portion 61d of the yoke 61 is formed enough long to cover the vibration range of the driving coil 34.

In the case of the coil 62 for the electromagnet which is wound around the center pole 61b of the yoke 61, the winding direction and the electric current flow direction of the coil 62 are set so that the top portion of the center pole 61b forms the N-pole, and the magnetic gap formation portion 61d forms the S-pole.

Therefore, if the sinusoidal driving signal whose polarity changes periodically is applied to the driving coil 34, the alternating-current (AC) rotational magnetic field of the driving coil 34 and the DC magnetic field in the magnetic gap interact and thus the driving coil 34 wound around the bobbin 39 moves and vibrates up and down in the magnetic gap according to the Fleming's left-hand law. As a result, the diaphragm 22 vibrates up and down.

Hereinbelow, the electromagnet style vibration generator as constructed above will be described.

First, if DC power is applied to the coil 62 for the electromagnet and the coil 62 is excited, the yoke 61 forms an electromagnet accordingly. As a result, the top portion of the center pole 61b forms the N-pole, and the magnetic gap formation portion 61d forms the S-pole. Accordingly, the magnetic gap is formed between the top portion of the center pole 61b and the magnetic gap formation portion 61d in the magnetic circuit formed by the yoke 61 of the electromagnet 63.

At this point, if a user sets the number of vibrations through the manipulator 45, the sinusoidal driving signal having a selected frequency is generated from the signal generator 41, accordingly, and is then applied to the amplifier 43.

The pre-amplifier of the amplifier 43 performs voltage amplification in advance so that sufficient power amplification may be attained in the power amplifier at the rear end of the amplifier 43. Then, the power amplifier of the amplifier 43 performs power amplification of the voltage amplified sinusoidal driving signal into a selected value according to user's set value of the amplitude of vibrations. Then, the power amplified sinusoidal driving signal is applied to the driving coil 34 which is wound around the bobbin 39.

Therefore, if the sinusoidal driving signal whose polarity changes periodically is applied to the driving coil 34, the alternating-current (AC) rotational magnetic field of the driving coil 34 and the DC magnetic field in the magnetic gap interact and thus the driving coil 34 wound around the bobbin 39 moves and vibrates up and down in the magnetic gap according to the Fleming's left-hand law, since the polarity of the sinusoidal driving signal is periodically inverted As a result, the diaphragm 22 vibrates up and down.

In the case of the electromagnet style vertical vibration unit 60 according to this invention, the diaphragm 22 moves up and down along the guide 23 in correspondence to the inversion of the polarity of the sinusoidal driving signal. Accordingly, the user can control an accurate number of times of vertical movements in correspondence to the frequency setting of the sinusoidal driving signal. In addition, since the guide rod 24 slides up and down through the vertical bearing of the guide 23 at the time of the vertical movements, less noise occurs.

In the vibration generator according to the second embodiment of the present invention illustrated in FIG. 10, a case that only a electromagnet style vertical vibration unit 60 is used in the vibration generator has been illustrated, but two or more vibration generators may be aligned in the front and rear direction of the seat 50.

Meanwhile, according to the first embodiment of the present invention, as shown in FIG. 8, the vertical vibration unit 30 has a structure that first and second magnetic circuits are formed using an external magnetic type style magnet 32b and an internal magnetic type style magnet 32a, a uniform distribution of the line of the magnetic force is realized on the surface opposed to a yoke 31 which forms a magnetic gap 33 of the first magnetic circuit including the external magnetic type style magnet 32b, a flux leakage of the magnetic gap 33 is prevented by the loop type second magnetic circuit including the internal magnetic type style magnet 32a.

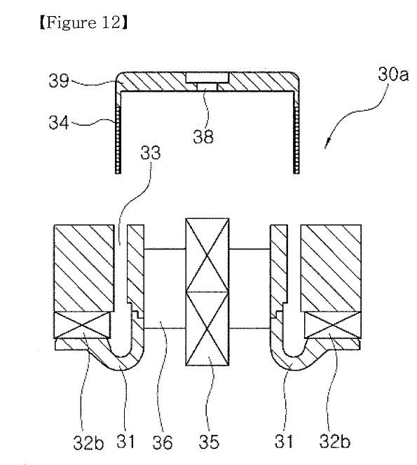

However, it is possible to modify the vertical vibration unit into that according to a third embodiment of the present invention illustrated in FIG. 12 unless the vertical vibration unit 30 has a strict regulation about flux leakage.

That is, the vertical vibration unit 30a according to the third embodiment includes only a first magnetic circuit which includes an external magnetic type style magnet 32b and forms a magnetic gap 33, and excludes a loop type second magnetic circuit including an internal magnetic type style magnet 32a.

That is, the first magnetic circuit includes the external magnetic type style magnet 32b, an extension portion which is extended upwards in the form of a pole piece at a distance from the inner circumference of the outer portion of the yoke 31 which is disposed at the lower portion of the external magnetic type style magnet 32b, and the inner portion of the yoke 31 which is disposed at the upper portion of the external magnetic type style magnet 32b in which the magnetic gap 33 is formed between the inner portion of the yoke 31 and a surface opposed to the extension portion of the pole piece form.

The bobbin 39 around which driving coils 34 are wound is inserted into the magnetic gap 33 formed in the magnetic circuit, in order to drive the diaphragm 22 up and down.

In the case that a single external magnetic type style magnet 32b is used as in the third embodiment of the present invention, magnets which are molded into disc shaped division pieces using a neodymium magnetic material having a flux density not less than 11.5 times than that of the conventional ferrite magnetic material, and then is strongly magnetized by a direct magnetization method. In addition, it is preferable that the vibration generator includes a pair of vertical vibration units 30a in order to obtain a preset vertical vibration force.

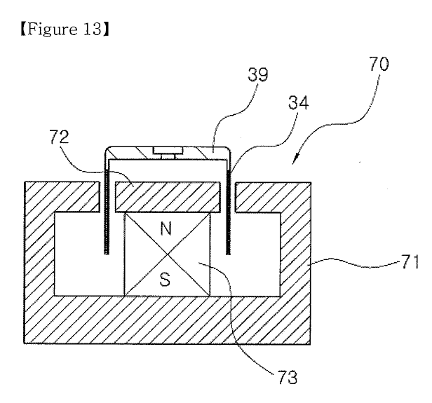

In addition, as illustrated in FIG. 13 in this invention, it is possible to use a permanent magnet style vertical vibration unit 70 according to a fourth embodiment having an internal magnetic type style magnetic circuit.

That is, as shown in FIG. 13, the permanent magnet style vertical vibration unit 70 according to the fourth embodiment has a structure that a single magnet 73 is installed in the inside of a yoke 71, and a bobbin 39 around which a driving coil 34 is wound is positioned in a magnetic gap of a magnetic circuit in which a top plate 72 is placed on the upper portion of the magnet 73.

The permanent magnet style vertical vibration unit 70 has a structure that a diaphragm 22 and the driving coil 34 which are connected with a bobbin 39 vibrate up and down and generate vertical vibrations in correspondence to a driving signal, by attraction and repelling forces which are generated according to the Fleming's left-hand law, by an interaction of a non-alternating (DC) magnetic flux which is generated from a fixed magnetic circuit and an alternating (AC) rotational magnetic flux which is generated from the driving coil 34 which can moves up and down.

It is desirable to use a neodymium magnetic material as a material of the magnet 73 even in the permanent magnet style vertical vibration unit 70. It is also desirable that a vibration generator using the magnet 73 using a neodymium magnetic material includes two or more vertical vibration units 70 in order to get a preset vertical vibration force.

In this invention, vertical movement is performed in accurately correspondence to the number of vibrations, that is, the frequency that the user has set. The bobbin around which the driving coil is wound and which is connected to the diaphragm is inserted into the magnetic gap of the magnetic circuit using an electromagnet or permanent magnets, so that the driving coil generates a strong magnetic force even at the low-frequency fewer than or equal to 20 Hz, to thus provide a sufficient vertical movement.

Meanwhile, the driving signal of the signal generator has a frequency in the range of 0.1 Hz to 20 kHz. For the purpose of diet, it is preferable that the driving signal of the signal generator has a frequency in the range of 3 to 50 Hz. For the purpose of bodily rehabilitation, it is preferable that the driving signal of the signal generator has a frequency in the range of 0.1 Hz to 25 Hz. For the purpose of cleaning and extension of capillary tubes, it is preferable that the driving signal of the signal generator has a frequency of about 20 kHz. For the purpose of making an exercise of internal organs, it is preferable that the driving signal of the signal generator has a frequency depending on a resonance frequency for the internal organs.

The vibration type exercise function chair has a strong vibratory force that the diaphragm can perform vertical movement of 10 mm or more even in the case that a user whose weight is 200 Kg sits on the chair.

Therefore, a vibration type exercise function chair, or a chair which can be transformed into a bed, according to the present invention, includes a vibration generator which can produce a strong vibratory force. Accordingly, the vibration type exercise function chair, or a chair which can be transformed into a bed, according to the present invention, can be appropriately used as a medical rehabilitation treatment apparatus or a functional exercising apparatus which enables the uncomfortable disabled person, the old or weak or the fat child, or the patient who undergoes rehabilitation treatment or the patient who is in the hospital and suffers from living a bed life for a long time to make a light exercise or perform physiotherapy, in which the number of vibrations (that is, the frequency) and the vibration width or amplitude (that is, a vibration strength) are appropriately set.

In addition, the chair having a sonic vibration type exercise function according to this invention can provide a massage service for diet exercise and fatigue recovery for a person who sits on the chair by appropriately controlling vibration frequency and strength according to need even in the office hours.

Moreover, in this invention, a low-frequency driving signal of 3 to 50 Hz for diet exercise and an audio signal of 30 to 20,000 Hz for listening to music may be selectively applied to the vertical vibration unit or overlapped at the same time, to then be applied to the vertical vibration unit.

In this case, the audio signal is saved in a memory 48, and the audio signal which is saved in the memory 48 is reproduced by the controller 40, if the user chooses the audio signal through an audio selection unit 45e in the manipulator 45 of FIG. 9. The reproduced audio signal is applied to the amplifier 43, and then the amplified audio signal is applied to the driving coil 34.

For example, if the low-frequency driving signal and the audio signal for listening to music are selectively applied to the driving coil, a low-frequency vibration is attained or an acoustic sound corresponding to the audio signal is produced. In addition, if the low-frequency driving signal and the audio signal for listening to music are overlapped and the overlapped result is applied to the driving coil, the diaphragm can perform a vertical movement according to the low-frequency driving signal to thus provide an exercise function effect, and simultaneously an acoustic signal according to reproduction of the audio signal is generated to thus enable the user to listen to music. Therefore, in this invention, users can do exercise while listening to music without using a special audio signal sound reproduction system such as a speaker.

Thus, in the case that an audio signal instead of a low-frequency driving signal is applied to the driving coil in this invention, the vibration amplitude of the diaphragm decreases in inverse proportion to the frequency of driving frequency, and voice conversion is achieved.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, a chair according to the present invention has a sonic vibration type exercise function, which applies periodic vertical vibration to user's body when a user sits on the chair for exercise and treatment, to thereby reveal an exercise and curative effect.

A chair according to the present invention includes a tread board and a chair back which can be pivotably provided, so that the chair can be transformed into a bed as necessary, to thereby be used as a medical functional bed and enable a user to lie down on the medical functional bed to make an exercise and receive a medical treatment.

A chair according to the present invention has a sonic vibration type exercise function, in which a low-frequency driving signal for a diet exercise and an audio signal for listening to music are selectively applied or simultaneously overlapped each other to then be applied to a diaphragm, to thereby enable the diaphragm to operate at low-frequency signals and a user to listen to music according to reproduction of audio signals and to accordingly enable the user to make an exercise while listening to music without using a special audio signal sound reproduction system such as a speaker.

1. A chair having a sonic vibration type exercise function, the chair comprising:
a seat;
a vibration generator which is placed at the lower part of the seat and provides vertical vibration for the seat;
a seat housing which supports the vibration generator at the lower part of the seat; and
a support which supports the lower part of the seat housing on the ground,
wherein the vibration generator comprises:
a base which is placed on the seat housing;
a controller which generates a driving signal;
at least one vertical vibration unit having a diaphragm which is placed on the base so as to be vibrated up and down, and which is vibrated up and down when the driving signal is applied to a driving coil which is wound around the outer circumference of a bobbin which is connected with the diaphragm by a magnetic gap driving method and is disposed in the magnetic gap;
a number of guides whose both ends are connected with the base and the diaphragm, to thereby guide vertical movement of the diaphragm; and
a number of vibration absorption units which restrict the range of motion of the diaphragm when the diaphragm moves in the vertical direction, and which absorbs impact when the diaphragm descends.

2. The chair according to claim 1, wherein the magnetic circuit that forms the magnetic gap in the vertical vibration unit comprises any one of an internal magnetic type permanent magnet, an external magnetic type permanent magnet, a combination of permanent magnets having a pair of an internal magnetic type permanent magnet and an external magnetic type permanent magnet, and an electromagnet.

3. The chair according to claim 1, wherein the controller comprises: a control unit which produces a control signal corresponding to an input set by user's manipulator; a signal generator which generates a sinusoidal driving signal having an oscillation signal set according to the control signal; and an amplifier for amplifying the sinusoidal driving signal.

4. The chair according to claim 1, further comprising a tread board whose one end is pivotably connected with the front end of the seat, and a chair back whose lower end is pivotably connected with the rear end of the seat.

5. The chair according to claim 1, wherein the controller further comprises a manipulator which sets a signal of controlling the number of vibrations and the amplitude of vibrations of the vertical vibration unit.

6. The chair according to claim 1, wherein the guide comprises a guide bearing which is placed in the base and a guide rod which is placed in the diaphragm and combined with the guide bearing.

7. The chair according to claim 1, further comprising a pair of arm rests which are installed in the left and right sides of the seat, respectively, and a display which is installed on the upper portion of the one arm rest and which is connected with the controller, to thereby display an operational state of the vibration generator.

8. The chair according to claim 1, further comprising a load sensor that is placed in the diaphragm to sense a load, and wherein the controller detects user's weight who stands on the diaphragm through the load sensor, to thereby drive the vertical vibration unit at the number of vibrations and the amplitude of vibrations which are appropriate for the sensed weight.

9. The chair according to claim 1, wherein the number of the guides and the number of the vibration absorption units are installed at an identical point in place.

10. The chair according to claim 3, wherein an oscillation frequency of the signal generator is set in the range of 0.1 Hz to 20 kHz.

11. The chair according to claim 1, wherein the driving signal is one of a low-frequency driving signal for a diet exercise, an audio signal or listening to music, and a signal which is obtained by overlapping a low-frequency driving signal and an audio signal.

12. A chair having a sonic vibration type exercise function, the chair comprising:
a seat;
a vibration generator which includes a diaphragm which is placed at the lower part of the seat and provides vertical vibration for the seat, so as to be vibrated up and down, and which enables the diaphragm to be vibrated up and down when a driving signal is applied;
a controller that produces the driving signal to vibrate the diaphragm of the vibration generator;
a seat housing which supports the vibration generator at the lower part of the seat; and
a support which supports the lower part of the seat housing on the ground,
wherein the vibration generator comprises:
at least one vertical vibration unit including: having lower and upper magnets which are arranged at a predetermined distance from each other so as to face each other and produces a non-alternating magnetic field; a first yoke which includes a loop type circulation circuit portion which is extended to the upper surface of the upper magnet from the lower surface of the lower magnet, and an extension portion which is extended vertically upwards at a predetermined interval from the inner circumference of the lower side of the lower magnet in an integral form; a second yoke which is connected between the lower and upper magnets and which forms a magnetic gap between the inner circumferential surface of the first yoke and the outer circumferential surface of the extension portion of the first yoke; a driving coil which generates an alternating magnetic field when the driving signal is applied thereto, and which is arranged in the magnetic gap, to then be displaced up and down according to interaction with a non-alternating magnetic field generated from the lower and upper magnets; and a cylindrical bobbin around which the driving coil is wound;
a joint whose one end is combined with the upper portion of each bobbin;
a diaphragm which is combined with the other end of the joint;
a base on one surface of which the vertical vibration unit is installed;
a number of guides whose both ends are connected with the base and the diaphragm, to thereby guide vertical movement of the diaphragm; and
a number of vibration absorption units which restrict the range of motion of the diaphragm when the diaphragm moves in the vertical direction, and which absorbs impact when the diaphragm descends.

13. The chair according to claim 12, wherein the controller comprises: a control unit which produces a control signal corresponding to an input set by user's manipulator; a signal generator which generates a sinusoidal driving signal having an oscillation signal set according to the control signal; and an amplifier for amplifying the sinusoidal driving signal.

14. The chair according to claim 12, further comprising a tread board whose one end is pivotably connected with the front end of the seat, and a chair back whose lower end is pivotably connected with the rear end of the seat.

15. The chair according to claim 12, wherein the guide comprises a guide bearing which is placed in the base and a guide rod which is placed in the diaphragm and combined with the guide bearing.

16. The chair according to claim 12, wherein the lower and upper magnets are arranged so that the respective N-poles face each other, and are formed of a number of sectional type disks made of neodymium.

17. The chair according to claim 12, wherein the controller further comprises
a manipulator which sets a signal of controlling the number of vibrations and the amplitude of vibrations of the vertical vibration unit, and
wherein the chair further comprises
a pair of arm rests which are installed in the left and right sides of the seat, respectively, and
a display which is installed on the upper portion of the one arm rest and which is connected with the controller, to thereby display an operational state of the vibration generator.

18. The chair according to claim 12, further comprising a load sensor that is placed in the diaphragm to sense a load, and wherein the controller detects user's weight who stands on the diaphragm through the load sensor, to thereby drive the vertical vibration unit at the number of vibrations and the amplitude of vibrations which are appropriate for the sensed weight.

19. The chair according to claim 13, wherein an oscillation frequency of the signal generator is set in the range of 0.1 Hz to 20 kHz.

20. The chair according to claim 12, wherein the driving signal is one of a low-frequency driving signal for a diet exercise, an audio signal or listening to music, and a signal which is obtained by overlapping a low-frequency driving signal and an audio signal.
